(19) United States
(12) Patent Application Publication
(10) Pub. No.: US 2026/0080320 A1
(43) Pub. Date: Mar. 19, 2026

(54) INTELLIGENT RESPONSES TO DATA REQUESTS

(71) Applicant: International Business Machines Corporation, Armonk, NY (US)

(72) Inventors: Gregory Frank Coppola, SHELTON, CT (US); SANJEEV KUMAR VENKAT MARIMEKALA, Farmington, CT (US); Chris Dotson, LEXINGTON, NY (US)

(73) Assignee: International Business Machines Corporation, Armonk, NY (US)

(21) Appl. No.: 18/886,472

(22) Filed: Sep. 16, 2024

(51) Int. Cl. G06N 20/20

(52) U.S. Cl. CPC G06N 20/20

(57) ABSTRACT

An embodiment includes generating, responsive to detecting a data request by a system, a response attribute by a machine learning model based on the data request wherein the machine learning model is trained on a historical attribute metric. The embodiment includes determining a validation metric corresponding to the machine learning model, wherein different machine learning models correspond to different validation metrics. The embodiment also includes deciding, by the system to modify the response attribute, by selecting the machine learning model with a greatest validation metric determined for the response attribute.

### BACKGROUND

The present invention relates generally to artificial intelligence. More particularly, the present invention relates to a method, system, and computer program for Intelligent Responses to Data Requests.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

A compliance audit is a formal review process that evaluates whether an organization is adhering to laws, regulations, policies, and industry standards relevant to its operations. It is conducted to ensure the organization is operating in a legal and ethical manner. The audit report covers the strength of compliance preparations, security policies, risk management procedures, and user access controls over the span of the audit. It fills any gaps in compliance while also making recommendations for ways to solve the issues. Compliance audits assist in confirming procedures such as: safeguarding confidential information, financial record-keeping, adherence to health and safety protocols, payroll management, compliance with human resources policies, and upholding management standards. Examples of compliance audits include SO/IEC 27K Series, Health Insurance Portability and Accountability Act (HIPAA), Sarbanes-Oxley Act, General Data Protection Regulation, and the Payment Card Industry Data Security Standard.

### SUMMARY

The illustrative embodiments provide for Intelligent Responses to Data Requests. An embodiment includes detecting a data request by a system. The embodiment includes generating, responsive to detecting a data request by a system, a response attribute by a machine learning model of the system based on the data request wherein the machine learning model is trained on a historical attribute metric. The embodiment includes determining a validation metric corresponding to the machine learning model, wherein different machine learning models correspond to different validation metrics. The embodiment also includes deciding, by the system to modify the response attribute, by selecting the machine learning model with a greatest validation metric.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a diagram in an environment in accordance with an illustrative embodiment;

FIG. 3 depicts a flowchart diagram in accordance with an illustrative embodiment;

FIG. 4 depicts a flowchart diagram in accordance with an illustrative embodiment; and

FIG. 5 depicts a system diagram in accordance with an illustrative embodiment.

### DETAILED DESCRIPTION

Responding to audit requests require collecting evidence, reconciling spreadsheets, and resolving any resulting issues. Missing or inaccurate data in the final report could compromise the report and present inaccurate data to customers and prospects. Compliance systems simplify the auditing process. With continuous monitoring and evidence collection, all the necessary information is already in one place. Certifying compliance continuously rather than at a point in time gives customers more confidence in the responding company's ability to maintain compliance and gives it an advantage on its competitors.

Current methods and systems of responding to data requests involves several teams, is time consuming and does not take into consideration responses to similar data requests from previous audits. This can lead to inconsistent or even incorrect responses to the requests. Additionally, increasing complexity of regulations and the requirements to speedily respond to data requests introduce more demands on systems.

The present disclosure provides a process (as well as a system, method, machine-readable medium, etc.) for Intelligent Responses to Data Requests. An embodiment includes detecting a data request by a system. Embodiments disclosed herein describe the system as comprising a machine learning model, a graphical user interface component and a component to compute a validation metric and make a decision. It should be understood that the functions of the various components may be combined to result in fewer components. For example, in some embodiments, the machine learnings component, and the component to compute a validation metric and make a decision may be combined into one component. Embodiments disclosed herein describe a machine learning component as using a machine learning algorithm to perform machine learning tasks including but not limited to predicting, clustering, and regression.

In embodiments, the system detects a data request from data sources of the network where the data request may comprise of data collected from monitoring network component such as GitHub issue, and ticket system such as JIRA and ServiceNow SNOW in a variety of data formats including Extensible Markup Language (XML), binary stream, hexadecimal, Hypertext Markup Language (HTML) and other structured and unstructured data formats.

Embodiments disclosed herein describe generating, responsive to detecting a data request, a response attribute by machine learning models of the system based on the data request where the machine learning models are trained on a historical attribute metric. A data request may comprise of questions or queries describing a clear description of the data required and frequency, how the data will be used, shared or distributed and to whom, and how the data will be exchanged and managed.

A response attribute as disclosed herein may describe a property or value of a response to a question or query of the data request. The queries and the responses may be structured in the form of attributes including but not limited to identifiers such as compliance program, action requested, and response format.

In embodiments, a machine learning model may be trained with historical attribute metric, where the training comprises using known supervised machine learning techniques based on an attribute of a historical data requests as labels where the historical attribute metric may comprise an attribute of the query and response, and its validation metric that is generated by machine learning algorithms. In another embodiment, a machine learning model may be trained with historical attribute metric, where the training comprises using known unlabeled unsupervised machine learning techniques.

In some embodiments disclosed herein the system may comprise of a plurality of machine learning models implemented in a sequence based on the machine learning algorithm, for example, a first machine learning model may implement a Gradient Boosting Machine, the second machine model may implement the Random Forest algorithm and the third machine learning model implements the deep learning algorithm.

Embodiments disclosed herein describe determining by the system a validation metric of the response attribute based on each of the machine learning models. In embodiments, a validation metric comprises a metric generated by a machine learning model including but not limited to a confidence rating that an attribute of the response to the data request is responsive to the data request. A confidence rating that in embodiments may comprise of a number or text determination of the responsiveness of the response attribute to a query, as determined by a machine learning model. A relevancy index may in embodiments be generated from the validation metric where the relevancy index may comprise of an index such as “least relevant” and “most relevant”. A validation metric may also be user defined or pre-defined.

Embodiments disclosed herein also describe deciding, by the system to modify the response attribute by selecting the machine learning model with a greatest validation metric. The term “modify” as used herein may mean to change a value of the response attribute to a different value. In some embodiments, the term may also mean changing the format from one type to another such as binary to hexadecimal or HTML to XML.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

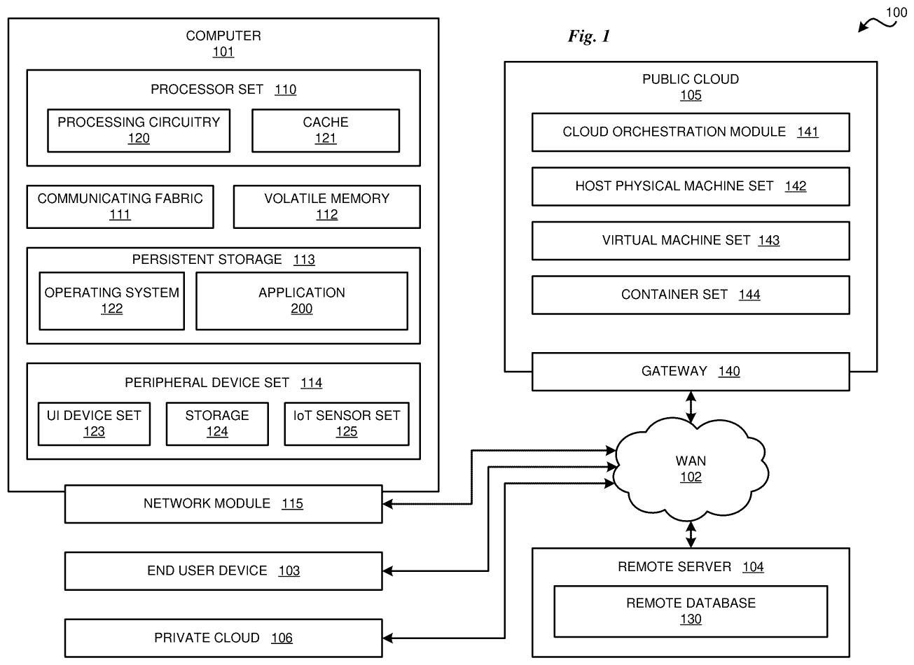

With reference to FIG. 1, this figure depicts a block diagram of a computing environment 100. Data center environment 100 contains an example of an environment for the execution of at least some of the computer code involved in performing the inventive methods, such as an Application module 200 that provides Intelligent Responses to Data Requests. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

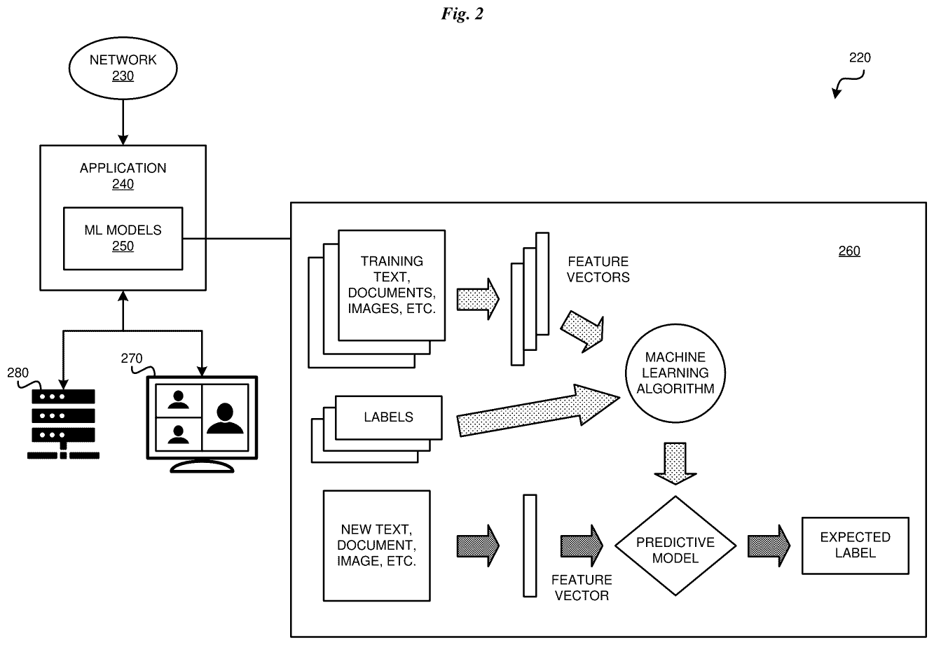

FIG. 2 depicts a diagram in an environment in accordance with an illustrative embodiment. In a particular embodiment, the diagram 220 shows aspects of the application 200 of FIG. 1.

In the illustrated embodiment, a new data request is detected by the system from a network 230. In embodiments, the platform detects data from data sources of the network. In other embodiments, the data sources are monitored and comes from multiple dimensions and types of data, which can include data collected from monitoring systems, including environment data, device operation data, and inspection data.

In embodiments, the data request may comprise of data collected from monitoring network component such as GitHub issue, and ticket system such as JIRA and ServiceNow SNOW in a variety of data formats including Extensible Markup Language (XML), binary stream, hexadecimal, Hypertext Markup Language (HTML) and other structured and unstructured data formats.

In embodiments, the system may comprise of an Application 240 further comprising machine learning models 250, storage and processing servers 280 and graphical user interface (GUI) 270. In embodiments, machine learning models 250 may comprise of a supervised learning model 260 where the labeled data sets comprise attributes of historical data requests. As input data is fed into the model, it adjusts its weights until the model has been fitted appropriately. In an embodiment, the input data comprises training text, documents and images. For example, the documents may be historical attribute metrics of historical responses to data requests with associated confidence ratings. Supervised learning uses a training set to teach models to yield the desired output. This training dataset includes inputs and correct outputs, which allow the model to learn over time.

In some embodiments, the machine learning models 250 comprise of an unsupervised learning model that is given raw unlabeled historical data requests. In embodiments, the model infers similarities and differences of the response attributes of the historical data requests based on known methods such as clustering, association and dimensional reduction. It should be noted that in some embodiments, the machine learnings models may comprise of supervised and unsupervised learning models in combination.

In an embodiment, a feature vector represents a data request in a vector format where each element of the vector comprises a feature such as a particular attribute's occurrences in the data request. In another embodiment, a feature vector comprises properties of the data requests representing the patterns in the data requests. For example, the feature vectors may comprise response attributes of a plurality of historical data requests. The system performs matrix operations on a large amount of the data represented in the feature vectors to determine patterns in the data.

In embodiments, the machine learning model 250 may implement a machine learning algorithm such as gradient boosting which is an ensemble machine learning technique that combines a collection of weak models into a single, more accurate and efficient predictive model. These weak models are typically decision trees, which is why the algorithms are commonly referred to as gradient boosted decision trees (GBDTs). Gradient boosting algorithms work iteratively by adding new models sequentially, with each new addition aiming to resolve the errors made by the previous ones. The final prediction of the aggregate represents the sum of the individual predictions of all the models. Gradient boosting combines the gradient descent algorithm and boosting method, with a nod to each component included in its name.

In an embodiment, the machine learning model 250 implements linear regression which is used to identify the relationship between a dependent variable and one or more independent variables and is typically leveraged to make predictions about future outcomes. When there is only one independent variable and one dependent variable, it is known as simple linear regression. As the number of independent variables increases, it is referred to as multiple linear regression. For each type of linear regression, it seeks to plot a line of best fit, which is calculated through the method of least squares. However, unlike other regression models, this line is straight when plotted on a graph.

In another embodiment, the machine learning model 250 implements a Random forest model, a commonly-used machine learning algorithm, that combines the output of multiple decision trees to reach a single result. Random forests are made up of many decision trees, each of which is trained using a random subset of the training data. For example, a decision tree may be trained on a data request specific to a particular industry or organization. Random forest is used for both classification and regression purposes. The “forest” references a collection of uncorrelated decision trees, which are then merged together to reduce variance and create more accurate data predictions.

In some embodiments, the machine learning model 250 may implement a deep learning model where the input layer of the deep learning model processes and passes the data request and response attributes to layers further in the neural network. These hidden layers process information at different levels, adapting their behavior as they receive new information.

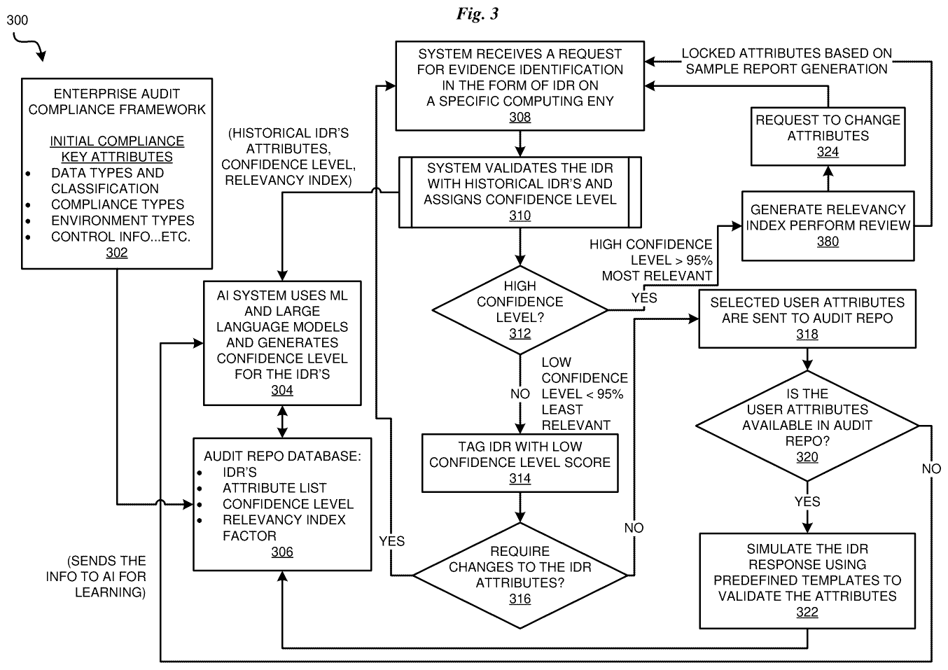

FIG. 3 depicts a flowchart diagram in accordance with an illustrative embodiment. In a particular embodiment, the components of the diagram 300 shows aspects of the application 200 of FIG. 1.

In the illustrated embodiment, a system receives an information data request (IDR) 308. The system validates the IDR using historical IDRs and assigns a confidence level to attributes of the IDR at step 310. In embodiments, this step 310 comprises generating a response attribute by machine learning models of the system based on the data request wherein the machine learning models are trained on a historical attribute metric. In another embodiment, the system determines a validation metric of the response attribute based on each of the machine learning models at step 304. For example, a validation metric is a confidence level, a relevancy index or a combination of both. In examples, the validation metric may be determined based on whether the response attribute is responsive to the IDR, or that the response attribute is relevant to the IDR, the determination may comprise of inputting into a first machine learning model, using the output as input into a second machine learning model, and using the output as input into a third machine learning model where the models are trained on historical attribute metric. As another example, the machine learning models may be implemented by the system as a sequence in a loop based on an algorithm of the machine learning model: first machine learning model may implement a Gradient Boosting Machine, the second machine model may implement the Random Forest algorithm, and the third machine learning model implements the deep learning algorithm. It should be noted that this is an exemplary depiction and each algorithm may be implemented by the machine learning model in a different sequence.

In an example, at step 312, the system decides if the validation metric such as the confidence level generated by a machine learning model is above a threshold. A threshold may be predefined such as client defined, it may be based on industry standard, or it may be determined by an unsupervised machine learning model.

In embodiments, the historical attribute metric comprising of an attribute and its associated attribute metric from historical data requests are archived in an archive repository 306. For example, the archive repository may comprise data requests, attribute list, and the associated validation metric such as confidence rating. In an embodiment, the archive repository may also comprise compliance framework 302.

If the validation metric of the response attribute comprising a confidence rating is above a threshold, for example 95%, the system may generate a relevancy index and perform a review at step 380. A relevancy index may in embodiments be generated from the confidence rating where the relevancy index may comprise of an index such as “least relevant” and “most relevant”. A request may be made to modify the response attribute at step 324. For example, a reviewer may request a modification to the response attribute, in which case, step 308 is repeated. Otherwise, the response attributes are used in the response to the data request, and the response attributes are archived in an archive repository.

If the validation metric of the response attribute comprising a confidence rating is below a threshold, for example, a low confidence rating of less than 95%, the system tags the response attribute with a low confidence rating at step 314. A decision is made whether the response attribute needs modification at step 316. If yes, step 308 is repeated. In some embodiments, the system selects another machine learning model next in the loop to generate a response attribute and validation metric. If no, the response attribute is prepared to be updated to the archive repository 318 and a decision is made 320 whether the attributes are available in the repository. In an embodiment, if yes, the response attribute may be validated against a predefined template 322 using known validation techniques, and the validated response attribute is sent to the archive repository 306. If no, the attributes with the low confidence rating tag are sent to update the machine learning models 304 and then sent to the archive repository 306.

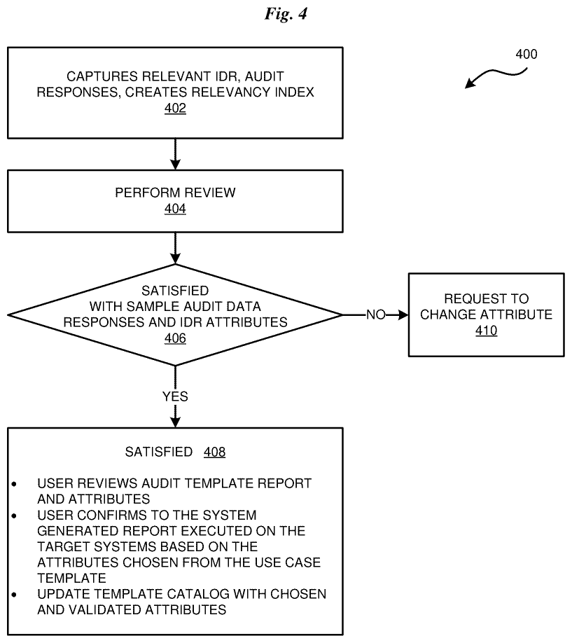

FIG. 4 depicts a flowchart diagram in accordance with an illustrative embodiment. In a particular embodiment, the components of the diagram 400 shows aspects of the application 200 of FIG. 1.

In the illustrated embodiment, a relevancy index of the response attribute, with a validation metric such as a confidence rating greater than a threshold, is generated 402. A relevancy index may in embodiments be generated from the validation metric where the relevancy index may comprise of an index such as “least relevant” and “most relevant”. A reviewer may review 404 the response attribute and its associated validation metric such as the confidence rating and relevancy index. In embodiments, a decision is made such as by a reviewer whether they are satisfied with the response attribute at step 406. If not satisfied, step 410 performs request to update attribute, which is also described in step 324. In an embodiment, if the reviewer is satisfied 408, the response to the data request is updated with the response attribute. The template and archive repository are also updated with the response attribute.

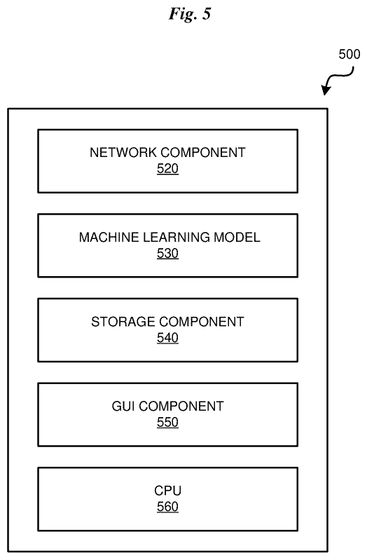

FIG. 5 depicts a system diagram in accordance with an illustrative embodiment. In a particular embodiment, the system components 500 are representative of aspects of the application 200 of FIG. 1.

In the illustrated embodiment, a system comprises a network component 520, a machine learning model 530, a storage component 540, a graphical user interface (GUI) component 550 and a central processing unit (CPU) 560. In an embodiment, the network component 520 comprises a router, network card, switch, a network interface card and related software. The network component may also include data aggregation layer that interacts with another component in the system. The machine learning model 530 may further comprise a neural network with an encoder-decoder architecture accepting input feature vectors to the machine learning model to perform predictions. Graphics Processing Units, (GPU) due to their ability to process tasks simultaneously, may be used for training the neural networks. By conducting numerous calculations at the same time, they can greatly decrease the processing time needed for the large volumes of data that machine learning models use. Tensor Processing Units, on the other hand, created specifically for executing machine learning tasks. Their ability to provide increased efficiency and speed while working with neural networks makes them a transformative technology for training machine learning models. The archive repository may be part of the storage component 540 comprising in embodiments of database server or a storage device. In some embodiments, the functionality described herein is distributed among a plurality of systems, which can include combinations of software and/or hardware-based systems, for example Application-Specific Integrated Circuits (ASICs), computer programs, or smart phone applications.

The embodiments described herein may provide for exemplary system to respond to an information technology (IT) audit data request. The system provides a solution that is particularly advantageous in the IT industry, where historical responses to data requests such as IT audits are not efficient considered. The data request may comprise of a JIRA ticket comprising of IT audit queries compliance program name and type. In this example, the system generates a response attribute by using machine learning models of the system based on the data request where each of the machine learning models are trained on a historical attribute metric using a gradient boosting algorithm, a random forest algorithm, or a deep learning algorithm. The system determines a validation metric of the response attribute based on each of the machine learning models. The system further decides to modify the response attribute based on the validation metric of the response attribute if the validation metric is less than a threshold of 95%. Otherwise, the response attribute is used as part of the response to the IT audit data request. In embodiments, the collaboration platform improves the functioning of a computer by training the machine learning models to improve their performance and accuracy. These may include training aspects of the model associated with certain features, values, labels and weights with large datasets historical response attributes to data requests.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
generating, responsive to detecting a data request by a system, a response attribute by a machine learning model based on the data request wherein the machine learning model is trained on a historical attribute metric;
determining a validation metric corresponding to the machine learning model, wherein different machine learning models correspond to different validation metrics; and
deciding, by the system to modify the response attribute, by selecting the machine learning model with a greatest validation metric determined for the response attribute.

2. The computer-implemented method of claim 1, further comprising deciding to use the response attribute to respond to the data request if the validation metric of the response attribute is greater than a threshold.

3. The computer-implemented method of claim 2, wherein the response attribute is archived as the historical attribute metric.

4. The computer-implemented method of claim 1, wherein determining the validation metric comprises generating a confidence rating of the response attribute.

5. The computer-implemented method of claim 1 wherein the machine learning model implements an algorithm comprising of a gradient boosting algorithm, a random forest algorithm, or a deep learning algorithm.

6. The computer-implemented method of claim 1, wherein the system comprises a plurality of machine learning models wherein the machine learning models are deployed in a sequence based on an algorithm of the machine learning model.

7. The computer-implemented method of claim 1, determining a validation metric comprises generating a relevancy index of the response attribute.

8. A computer program product comprising one or more computer readable storage media, and program instructions collectively stored on the one or more computer readable storage media, the program instructions executable by a processor to cause the processor to perform operations comprising:
generating, responsive to detecting a data request by a system, a response attribute by a machine learning model based on the data request wherein the machine learning model is trained on a historical attribute metric;
determining a validation metric corresponding to the machine learning model, wherein different machine learning models correspond to different validation metrics; and
deciding, by the system to modify the response attribute, by selecting the machine learning model with a greatest validation metric determined for the response attribute.

9. The computer program product of claim 8, further comprising deciding to use the response attribute to respond to the data request if the validation metric of the response attribute is greater than a threshold.

10. The computer program product of claim 9, wherein the response attribute is archived as the historical attribute metric.

11. The computer program product of claim 8, wherein determining the validation metric comprises generating a confidence rating of the response attribute.

12. The computer program product of claim 8, wherein the machine learning models implement a gradient boosting algorithm, a random forest algorithm, or a deep learning algorithm.

13. The computer program product of claim 8, wherein the system comprises a plurality of machine learning models wherein the machine learning models are deployed in a sequence based on an algorithm of the machine learning model.

14. The computer program product of claim 8, determining a validation metric comprises generating a relevancy index of the response attribute.

15. A computer system comprising a processor and one or more computer readable storage media, and program instructions collectively stored on the one or more computer readable storage media, the program instructions executable by the processor to cause the processor to perform operations comprising:
generating, responsive to detecting a data request by a system, a response attribute by a machine learning model based on the data request wherein the machine learning model is trained on a historical attribute metric;
determining a validation metric corresponding to the machine learning model, wherein different machine learning models correspond to different validation metrics; and
deciding, by the system to modify the response attribute, by selecting the machine learning model with a greatest validation metric determined for the response attribute.

16. The computer system of claim 15, further comprising deciding to use the response attribute to respond to the data request if the validation metric of the response attribute is greater than a threshold.

17. The computer system of claim 16, wherein the response attribute is archived as the historical attribute metric.

18. The computer system of claim 15, wherein determining the validation metric comprises generating a confidence rating of the response attribute.

19. The computer system of claim 15, wherein the machine learning models implement a gradient boosting algorithm, a random forest algorithm, or a deep learning algorithm.

20. The computer system of claim 15, wherein the system comprises a plurality of machine learning models wherein the machine learning models are deployed in a sequence based on an algorithm of the machine learning model.
